(19) United States
(12) Patent Application Publication
(10) Pub. No.: US 2022/0343629 A1
(43) Pub. Date: Oct. 27, 2022

(54) PROCESSING DEVICE, PROCESSING METHOD, AND COMPUTERREADABLE MEDIUM

(71) Applicant: NEC Corporation, Minato-ku, Tokyo (JP)

(72) Inventors: Yoshimasa ONO, Tokyo (JP); Akira TSUJI, Tokyo (JP); Junichi ABE, Tokyo (JP)

(73) Assignee: NEC Corporation, Minato-ku, Tokyo (JP)

(21) Appl. No.: 17/641,175

(22) PCT Filed: Sep. 20, 2019
(86) PCT No.: PCT/JP2019/036988

§ 371 Date: Mar. 8, 2022

(51) Int. Cl. G06V 10/764; G06V 10/762

(52) U.S. Cl. CPC G06V 10/764; G06V 10/762

(57) ABSTRACT

A processing device (10) includes a classification means (12) for classifying three-dimensional point cloud data acquired based on reflected light from a plurality of reinforcing steel bars irradiated with light in a bar arrangement inspection into clusters, which are shape units corresponding to the plurality of reinforcing steel bars, based on position information at each point in the three-dimensional point cloud data, a smoothing means (13) for smoothing the contours of the classified clusters, and a cluster association means (14) for determining whether a first cluster and a second cluster contained in the smoothed clusters correspond to the same reinforcing steel bar based on positional relation between the smoothed clusters.

### TECHNICAL FIELD

The present invention relates to a processing device, a processing method, and a computer-readable medium.

### BACKGROUND ART

When a reinforced concrete structure is built, it is necessary to perform a bar arrangement inspection to check where and what thickness of reinforcing steel bars are arranged. With regard to the bar arrangement inspection, the development of techniques of detecting the shapes of reinforcing steel bars has proceeded. For example, Patent Literature 1 discloses a technique of acquiring point cloud data about reinforcing steel bars using a three-dimensional laser scanner to detect the shapes of the reinforcing steel bars based on the acquired point cloud data.

### CITATION LIST

### Patent Literature

Patent Literature 1: Unexamined Patent Application Publication No. 2010-151577

### SUMMARY OF INVENTION

### Technical Problem

In order to detect the shapes of arranged reinforcing steel bars, acquired point cloud data about a plurality of reinforcing steel bars needs to be clustered based on position information of the point clouds. Clustering is a process for classifying point clouds considered to be the same structure as a cluster. However, since a large number of reinforcing steel bars are assembled vertically and horizontally in bar arrangement, the same reinforcing steel bar is classified as a plurality of clusters or different reinforcing steel bars are classified as the same cluster unintentionally in clustering. If the accuracy of clustering is not good as described above, there is a concern that a bar arrangement inspection cannot be conducted accurately.

The present invention has been made in view of the above, and a purpose of the present invention is to provide a processing device capable of processing point cloud data acquired from a plurality of reinforcing steel bars to accurately perform a bar arrangement inspection.

### Solution to Problem

A processing device according to a first aspect of the present invention includes a classification means for classifying three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data, a smoothing means for smoothing contours of the classified clusters, and a cluster association means for determining whether a first cluster and a second cluster contained in the smoothed clusters correspond to the same reinforcing steel bar based on positional relation between the smoothed clusters.

A processing method according to a second aspect of the present invention includes the steps of classifying three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data, smoothing contours of the classified clusters, and determining whether a first cluster and a second cluster contained in the classified clusters correspond to the same reinforcing steel bar based on positional relation between the smoothed clusters.

A non-transitory computer-readable medium according to a third aspect of the present invention stores a program causing a computer to execute the steps of classifying three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data, smoothing contours of the classified clusters, and determining whether a first cluster and a second cluster contained in the classified clusters correspond to the same reinforcing steel bar based on positional relation between the smoothed clusters.

### Advantageous Effects of Invention

According to the present invention, it is possible to process point cloud data acquired from a plurality of reinforcing steel bars to accurately perform a bar arrangement inspection.

### BRIEF DESCRIPTION OF DRAWINGS

FIG. 1 is a block diagram showing a configuration of a processing device according to a first example embodiment;

FIG. 2 is a block diagram showing a configuration of a processing device according to a second example embodiment;

FIG. 3 is a schematic diagram showing an external shape of a deformed steel bar;

FIG. 4 is a flowchart for explaining a procedure of processing point cloud data acquired from a plurality of reinforcing steel bars in the processing device according to the second example embodiment;

FIG. 5 is a diagram showing an example of smoothing a cluster acquired from a reinforcing steel bar;

FIG. 6 is a flowchart showing a procedure of processes in a subroutine in step S3 of FIG. 4;

FIG. 7 is a schematic diagram showing an example of a method for extracting contour lines by processes from steps S102 to S104;

FIG. 8 is a schematic diagram for concretely explaining the determination in step S105 of FIG. 6 as to whether the number of contour lines that match between a first contour-line group and a second contour-line group is equal to or greater than a threshold;

FIG. 9 is a schematic diagram for explaining the case where a first cluster and a second cluster are not associated although it is determined that the first contour-line group matches the second contour-line group in step S105 of FIG. 6;

FIG. 10 is a schematic diagram for explaining an example of a method for complementing a point cloud between a first cluster and a second cluster;

FIG. 11 is a schematic diagram for explaining a problem of determining whether to associate clusters acquired from reinforcing steel bars as the same reinforcing steel bar without leveling;

FIG. 12 is a block diagram showing a configuration of a cluster association means 214 according to a first modified example;

FIG. 13 is a flowchart for explaining a subroutine in step S3 of FIG. 4 according to the first modified example;

FIG. 14 is a schematic diagram for concretely explaining processes from steps S201 to S203 of FIG. 13;

FIG. 15 is a block diagram showing a configuration of a processing device according to a second modified example;

FIG. 16 is a flowchart for explaining a procedure of processing point cloud data acquired from a plurality of reinforcing steel bars in the processing device according to the second example embodiment, and is an example different from FIG. 4;

FIG. 17 is a schematic diagram for concretely explaining a process of point cloud data acquired from a plurality of reinforcing steel bars according to the second modified example;

FIG. 18 is a block diagram showing a configuration of a processing device according to a third modified example; and

FIG. 19 is a flowchart for explaining a procedure of processing point cloud data acquired from a plurality of reinforcing steel bars in the processing device, and is an example different from FIGS. 4 and 16.

### DESCRIPTION OF EMBODIMENTS

Hereinafter, example embodiments of the present invention will be described with reference to the drawings. The following description and the drawings are appropriately omitted or simplified to clarify the explanation. In the drawings, the same elements are denoted by the same reference signs, and duplicated descriptions are omitted as necessary. Note that, right-handed-system XYZ coordinates shown in the drawings are for convenience to explain the positional relation of constituent elements.

### First Example Embodiment

A first example embodiment is described below.

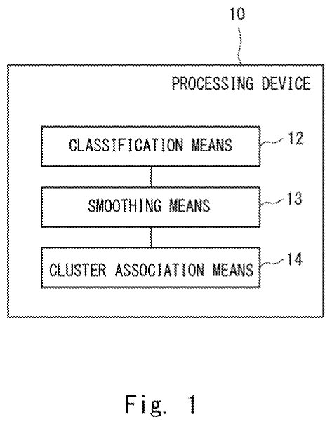

FIG. 1 is a block diagram showing a configuration of a processing device 10 according to the first example embodiment. As shown in FIG. 1, the processing device 10 includes a classification means 12, a smoothing means 13, and a cluster association means 14.

The classification means 12 classifies three-dimensional point cloud data acquired based on reflected light from a plurality of reinforcing steel bars irradiated with light in a bar arrangement inspection into clusters, which are shape units corresponding to the plurality of reinforcing steel bars, based on position information at each point in the three-dimensional point cloud data. The smoothing means 13 smooths the contours of the classified clusters. The cluster association means 14 determines whether a first cluster and a second cluster contained in the classified clusters correspond to the same reinforcing steel bar based on positional relation between the smoothed clusters.

With the processing device 10 having the above configuration, it is possible to process point cloud data acquired from a plurality of reinforcing steel bars to accurately perform a bar arrangement inspection.

### Second Example Embodiment

A second example embodiment is described below.

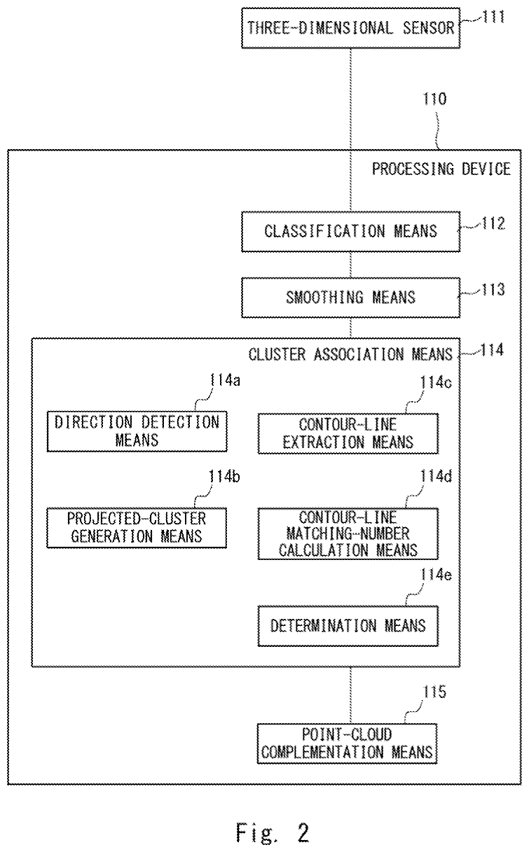

First, a configuration example of a processing device according to the second example embodiment is described. FIG. 2 is a block diagram showing a configuration of a processing device 110 according to the second example embodiment. As shown in FIG. 2, the processing device 110 includes a classification means 112, a smoothing means 113, a cluster association means 114, and a point-cloud complementation means 115.

The classification means 112 classifies point cloud data (three-dimensional point cloud data) acquired based on reflected light from a plurality of reinforcing steel bars irradiated with light in a bar arrangement inspection into clusters, which are shape units corresponding to the plurality of reinforcing steel bars, based on position information at each point in the point cloud data.

The plurality of reinforcing steel bars is irradiated with light by a three-dimensional sensor 111. The three-dimensional sensor 111 is capable of measuring a distance based at least on light amplitude information and irradiates a plurality of arranged reinforcing steel bars with light to acquire point cloud data. The three-dimensional sensor 111 is, for example, a 3D light detection and ranging (LiDAR) sensor.

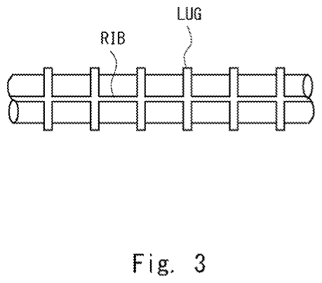

Reinforcing steel bars arranged when a reinforced concrete structure is built are called deformed steel bars (deformed reinforcing steel bars). FIG. 3 is a schematic diagram showing an external shape of a deformed steel bar. As shown in FIG. 3, deformed steel bars are provided with uneven protrusions called “ribs” and “lugs”. Deformed steel bars have standard names such as “D10”, “D13”, “D16”, and “D19” depending on the diameter. The numbers in the standard names indicate the approximate diameters of deformed steel bars: the diameter of D10 is 9.53 mm, and the diameter of D13 is 12.7 mm, for example. That is, the diameters of deformed steel bars are standardized every 2 to 3 mms.

Referring to FIG. 2 again, the smoothing means 113 smooths the contours of the clusters classified by the classification means 112. Here, as the method for smoothing the classified clusters, a general smoothing method can be used.

The cluster association means 114 determines whether a first cluster and a second cluster contained in the clusters smoothed by the smoothing means 113 correspond to the same reinforcing steel bar based on positional relation between the smoothed clusters. The cluster association means 114 includes a direction detection means 114a, a projected-cluster generation means 114b, a contour-line extraction means 114c, a contour-line matching-number calculation means 114d, and a determination means 114e.

The direction detection means 114a detects the direction of a cluster. For example, the direction detection means 114a detects the shortest direction in which the smallest number of points in a cluster are lined or the longest direction in which the largest number of points are lined. Here, the lining of the smallest number of points does not include the case where the number of points is zero. The projected-cluster generation means 114b generates a first projected cluster by projecting the first cluster on a plane perpendicular to the shortest direction of the first cluster and a second projected cluster by projecting the second cluster on a plane perpendicular to the shortest direction of the second cluster.

The contour-line extraction means 114c extracts the contour lines of the first cluster and the second cluster. The contour-line matching-number calculation means 114d calculates the number of contour lines that match between the first cluster and the second cluster. The determination means 114e determines whether to associate the first cluster and the second cluster as the same reinforcing steel bar based on the positional relation between the smoothed clusters.

When the cluster association means 114 determines that the first cluster and the second cluster are to be associated, the point-cloud complementation means 115 complements a point cloud between the first cluster and the second cluster.

Next, a procedure of processing point cloud data acquired from a plurality of reinforcing steel bars in the processing device 110 shown in FIG. 2 is described. Note that, FIG. 2 is appropriately referred to in the following description.

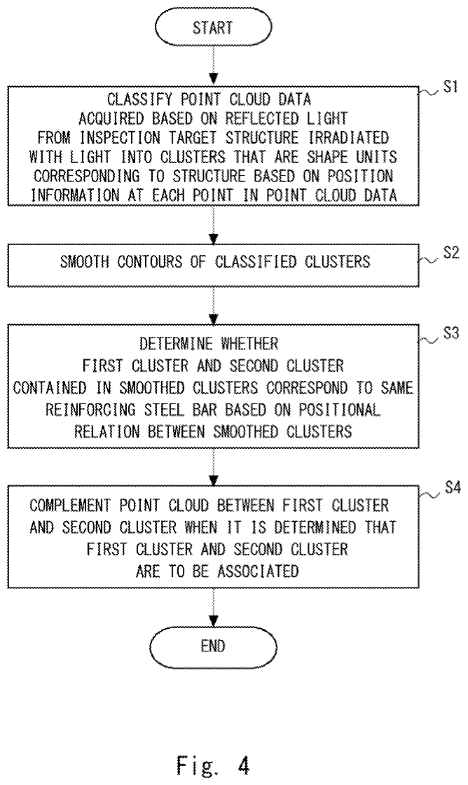

FIG. 4 is a flowchart for explaining a procedure of processing point cloud data acquired from a plurality of reinforcing steel bars in the processing device 110. As shown in FIG. 4, first, the classification means 112 classifies point cloud data acquired based on reflected light from a plurality of reinforcing steel bars irradiated with light into clusters, which are shape units corresponding to the plurality of reinforcing steel bars, based on position information at each point in the point cloud data (step S1). Then, the smoothing means 113 smooths the contours of the classified clusters (step S2). Then, the cluster association means 114 determines whether a first cluster and a second cluster contained in the smoothed clusters correspond to the same reinforcing steel bar based on positional relation between the smoothed clusters (step S3). Then, when the cluster association means 114 determines that the first cluster and the second cluster are to be associated, the point-cloud complementation means 115 complements a point cloud between the first cluster and the second cluster (step S4).

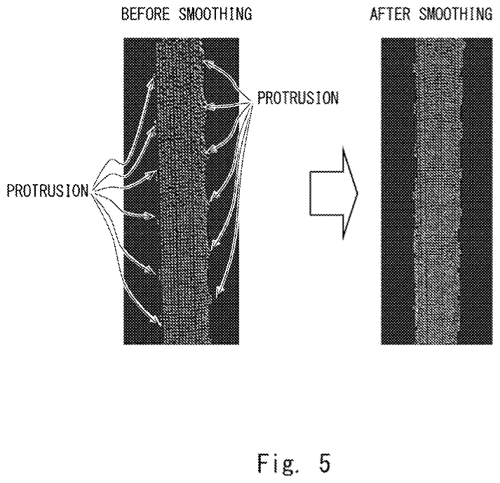

As described with reference to FIG. 3, a reinforcing steel bars has a lot of unevenness such as lugs and ribs on its surface. FIG. 5 is a diagram showing an example of smoothing a cluster from a reinforcing steel bar. As shown on the left side of FIG. 5, the contour of the cluster before smoothing has may protrusions corresponding to lugs. In contrast, as shown on the right side of FIG. 5, the cluster after smoothing has almost no protrusions. In this manner, by smoothing a cluster acquired from a reinforcing steel bar, it is possible to accurately detect the contour lines of the cluster. Accordingly, it is possible to accurately estimate the coupling relation between classified clusters. Note that, the method for detecting the contour lines of a cluster is described later.

Next, the method for determining whether to associate the first cluster and the second cluster as the same reinforcing steel bar in step S3 of FIG. 4 is concretely described. Note that, FIG. 2 is appropriately referred to in the following description.

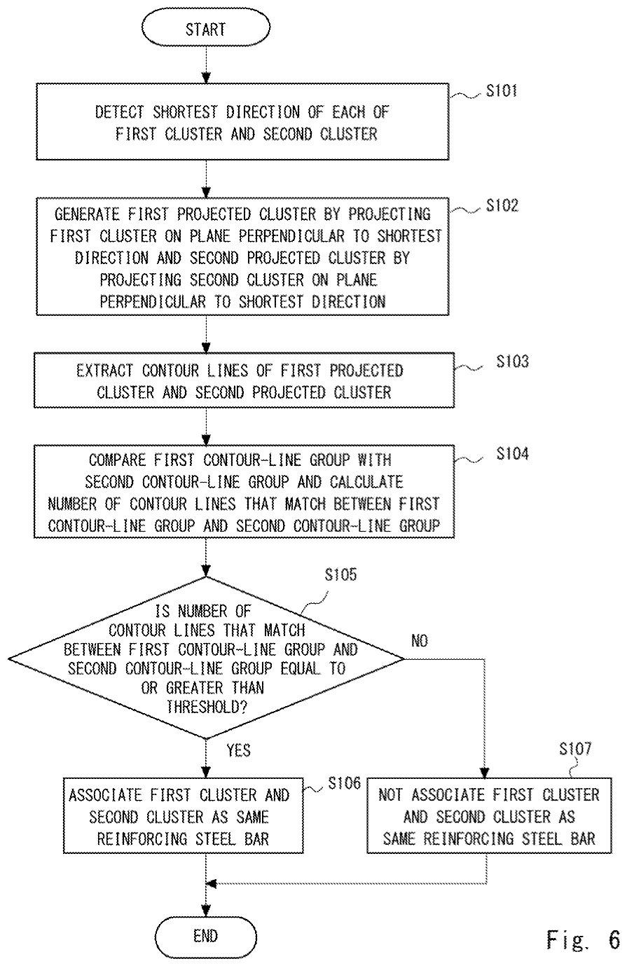

FIG. 6 is a flowchart showing a procedure of processes in a subroutine in step S3 of FIG. 4. As shown in FIG. 6, first, the direction detection means 114a detests the shortest direction of each of the first cluster and the second cluster (step S101). Then, the projected-cluster generation means 114b generates a first projected cluster by projecting the first cluster on a plane perpendicular to the shortest direction of the first cluster and a second projected cluster by projecting the second cluster on a plane perpendicular to the shortest direction of the second cluster (step S102).

Following step S102, the contour-line extraction means 114c extracts the contour lines of the first projected cluster and the second projected cluster (step S103). Then, the contour-line matching-number calculation means 114d compares a first contour-line group, which is a plurality of contour lines extracted from the first projected cluster, with a second contour-line group, which is a plurality of contour lines extracted from the second projected cluster, and calculates the number of contour lines that match between the first contour-line group and the second contour-line group (step S104).

Following step S104, the determination means 114e determines whether the number of contour lines that match between the first projected cluster and the second projected cluster is equal to or greater than a threshold (step S105). Here, in the case of reinforcing steel bars, the threshold is two. When the number of contour lines that match between the first projected cluster and the second projected cluster is equal to or greater than the threshold in step S105, the determination means 114e associates the first cluster and the second cluster as the same reinforcing steel bar (step S106). When the number of contour lines that match between the first cluster and the second cluster is less than the threshold in step S105, the determination means 114e does not associate the first cluster and the second cluster as the same reinforcing steel bar (step S107).

In step S101, as the method for detecting the shortest direction from the classified clusters, principle component analysis (PCA) can be applied. In principle component analysis, the eigenvalues of principle components (eigenvectors) are the variances. In principle component analysis, eigenvalues are referred to as a first principle component, a second principle component, and so on in descending order. A cluster consists of three parameters (x, y, z), and three principle components of a first principle component, a second principle component, and third principle component are obtained.

As described above, the shortest direction is the direction in which the smallest number of points detected from a cluster are lined. The shortest direction of a cluster C13 is detected by, for example, principle component analysis. In principle component analysis, the eigenvalue of the principle component corresponding to the variance of points is the smallest in the shortest direction. In other words, the third principle component having the smallest eigenvalue of the principle component is the shortest direction. Thus, by detecting the third principle component by principle component analysis, the shortest direction can be detected.

Note that, the longest direction in which the largest number of points in a cluster are lined can also be detected by principle component analysis. In the longest direction, the eigenvalue of the principle component corresponding to the variance of points is the largest. In other words, the first principle component having the largest eigenvalue of the principle component is the longest direction.

Next, an example of the method for extracting the contour lines by the processes from steps S102 to S104 is described. Since the contour of a cluster acquired from a reinforcing steel bar has curved parts, a projected cluster is generated by projecting the cluster on a plane perpendicular to the shortest direction to extract the contour lines from the projected cluster.

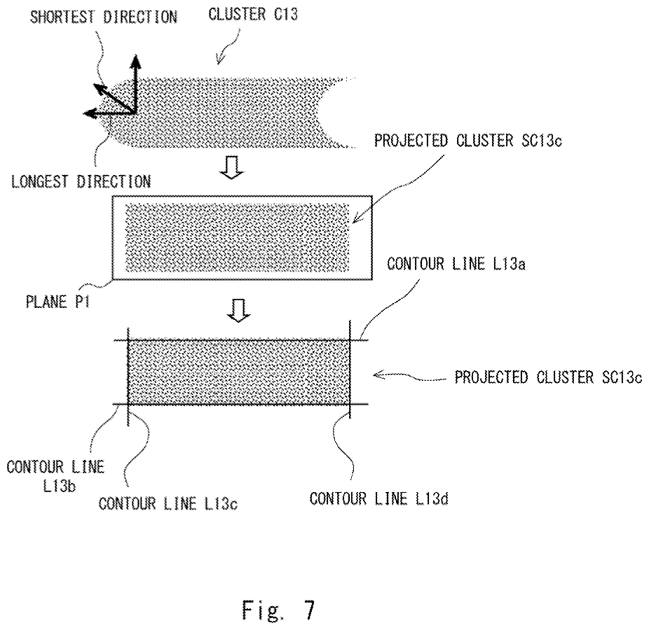

FIG. 7 is a schematic diagram for explaining an example of the method for extracting the contour lines by the processes from steps S102 to S104. As shown in FIG. 7, first, the shortest direction of the cluster C13 having a contour with curved parts is detected. Then, the cluster C13 is projected on a plane P1 perpendicular to the shortest direction. Then, contour lines (L13a, L13b, L13c, and L13d) are extracted from a projected cluster SC13c obtained by projecting the cluster C13 on the plane P1.

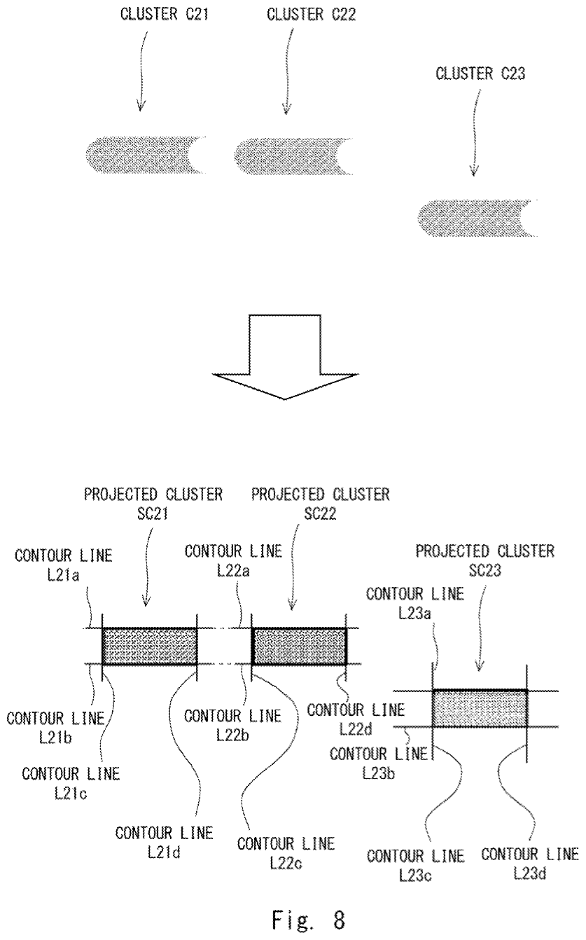

FIG. 8 is a schematic diagram for concretely explaining the determination in step S105 of FIG. 6 as to whether the number of contour lines that match between the first contour-line group and the second contour-line group is equal to or greater than a threshold. Here, it is assumed that the threshold for the number of matching contour lines is two.

As shown in FIG. 8, contour lines L21a, L21b, L21c, and L21d are extracted from a projected cluster SC21 of a cluster C21 after smoothing. Contour lines L22a, L22b, L22c, and L22d are extracted from a projected cluster SC22 of a cluster C22 after smoothing. Contour lines L23a, L23b, L23c, and L23d are extracted from a projected cluster SC23 of a cluster C23 after smoothing.

First, it is assumed that the first cluster is the cluster C21 and that the second cluster is the cluster C22. The first contour-line group includes the contour lines L21a, L21b, L21c, and L21d extracted from the projected cluster 21 of the cluster C21. The second contour-line group includes the contour lines L22a, L22b, L22c, and L22d extracted from the projected cluster SC22 of the cluster C22. Between the first contour-line group and the second contour-line group, the contour line L21a matches the contour line L22a, and the contour line L21b matches the contour line L22b. In other words, the number of contour lines that match between the first contour-line group and the second contour-line group is two and is equal to or greater than the threshold. Thus, the cluster C21 and the cluster C22 are associated as the same reinforcing steel bar.

Next, it is assumed that the first cluster is the cluster C21 and that the second cluster is a cluster C23. The first contour-line group includes the contour lines L21a, L21b, L21c, and L21d extracted from the projected cluster C21 of the cluster C21. The second contour-line group includes the contour lines L23a, L23b, L23c, and L23d extracted from the projected cluster SC23 of the cluster C23. Between the first contour-line group and the second contour-line group, no contour lines match. In other words, the number of contour lines that match between the first contour-line group and the second contour-line group is less than the threshold. Thus, the cluster C21 and the cluster C23 are not associated as the same reinforcing steel bar.

Next, a case where the first cluster and the second cluster are not associated although it is determined that the first contour-line group matches the second contour-line group in step S105 of FIG. 6 is described.

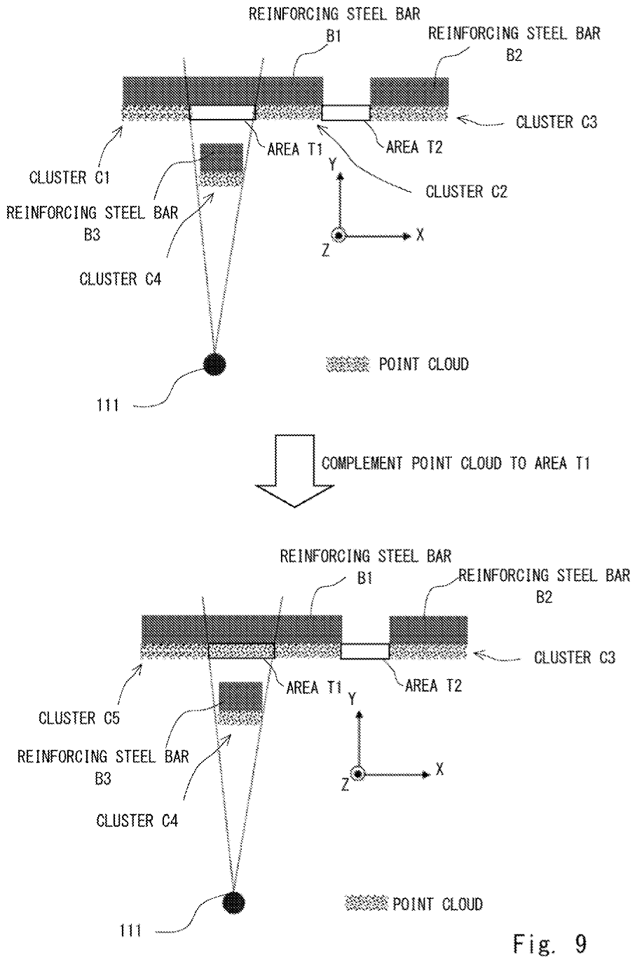

FIG. 9 is a schematic diagram for explaining the case where the first cluster and the second cluster are not associated although it is determined that the first contour-line group matches the second contour-line group in step S105 of FIG. 6. Here, it is assumed that the projected cluster of a cluster C1 matches the projected cluster of a cluster C2. In addition, it is assumed that the projected cluster of the cluster C2 matches the projected cluster of a cluster C3.

As shown in FIG. 9, both the cluster C1 and the cluster C2 are the point clouds acquired from a reinforcing steel bar B1, and the cluster C3 is the point cloud acquired from a reinforcing steel bar B2, and a cluster C4 is the point cloud acquired from a reinforcing steel bar B3. The cluster C1 and the cluster C2 are acquired from the same reinforcing steel bar and need to be associated as the same reinforcing steel bar. On the other hand, the cluster C2 and the cluster C3 are acquired from different reinforcing steel bars and should not to be associated as the same reinforcing steel bar.

When viewed from the three-dimensional sensor 111, the reinforcing steel bar B3 is located at the position in front of the reinforcing steel bar B1. For this reason, an area T1 of the reinforcing steel bar B1 is in the shadow of the reinforcing steel bar B3 and not irradiated with light from the three-dimensional sensor 111, and no point cloud is acquired from the area T1. When viewed from the three-dimensional sensor 111, the reinforcing steel bar B3 is located at the position in front of the area T1, and the point cloud is acquired from that position.

The reinforcing steel bar B1 and the reinforcing steel bar B2 are different reinforcing steel bars. For this reason, no point cloud is acquired from an area T2 between the reinforcing steel bar B1 and the reinforcing steel bar B2. When viewed from the three-dimensional sensor 111, no reinforcing steel bar is located at the position in front of the area T2, and no point cloud is acquired from that position either.

It can be possible that projected clusters generated from two clusters acquired from different reinforcing steel bars match accidentally like the cluster C2 and the cluster C3. Thus, the cluster association means 114 determines whether a third cluster containing a predetermined number of points or more is located at a position between and in front of the first cluster and the second cluster when viewed from the three-dimensional sensor. Then, the first cluster and the second cluster are associated when the third cluster is located, and the first cluster and the second cluster are not associated when the third cluster is not located.

That is, the cluster C4 is located at the position between and in front of the cluster C1 and the cluster C2 when viewed from the three-dimensional sensor 111, the cluster C1 and the cluster C2 are associated. On the other hand, no cluster containing the predetermined number of points or more is located at the position between and in front of the cluster C2 and the cluster C3 when viewed from the three-dimensional sensor 111, the cluster C2 and the cluster C3 are not associated. Then, the point-cloud complementation means 115 (see FIG. 2) completements a point cloud to the area T1 between the associated cluster C1 and cluster C2. Accordingly, a cluster C5 corresponding to the reinforcing steel bar B1 is obtained.

Next, the method for complementing a point cloud between the first cluster and the second cluster in step S4 of FIG. 4 is described.

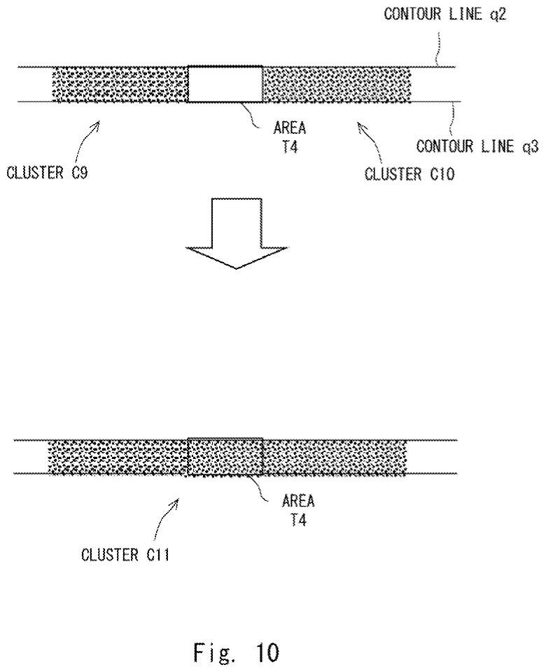

FIG. 10 is a schematic diagram for explaining an example of a method for complementing a point cloud between a first cluster and a second cluster. As shown in FIG. 10, it is assumed that two contour lines match between the contour lines of a cluster C9 and a cluster C10 (a contour line q2 matches a contour line q3). When two contour lines of the contours of the clusters match, a point cloud is complemented between the two contour lines facing each other (in this example, between the contour line q2 and the contour line q3) of the matching contour lines between the cluster C9 and the cluster C10 that are two clusters to be associated. Accordingly, a cluster C11 obtained by associating the cluster C9 and the cluster C10 as the same reinforcing steel bar is generated.

Next, a problem of determining whether to associate clusters acquired from reinforcing steel bars as the same reinforcing steel bar without leveling is described.

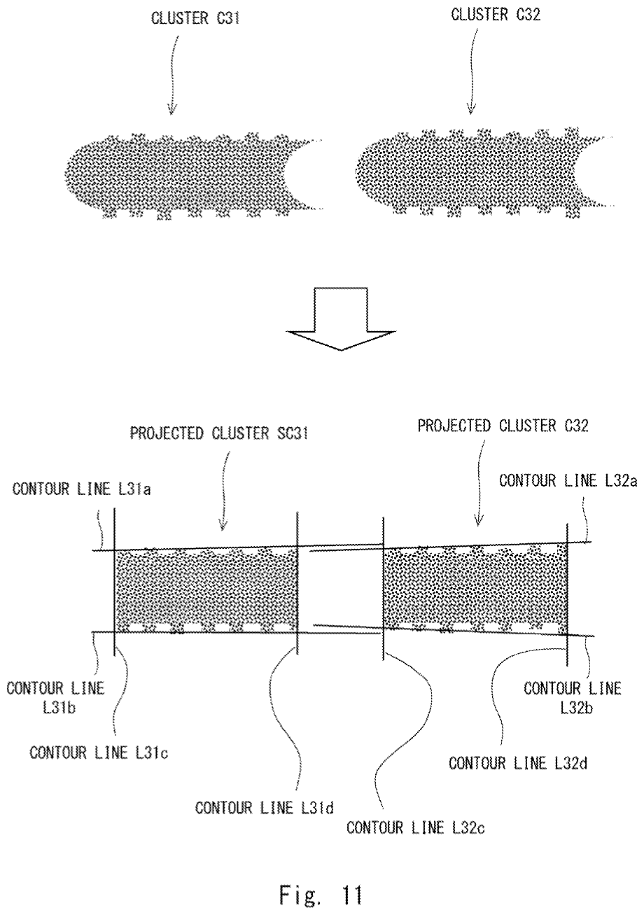

FIG. 11 is a schematic diagram for explaining a problem of determining whether to associate clusters acquired from reinforcing steel bars as the same reinforcing steel bar without leveling. It is assumed that a cluster C31 and a cluster C32 shown in FIG. 11 are acquired from the same reinforcing steel bar.

A projected cluster SC31 is obtained by projecting the cluster C31 on a plane perpendicular to the shortest direction, and a projected cluster SC32 is obtained by projecting the cluster C32 on a plane perpendicular to the shortest direction. Contour lines L31a, L31b, L31c, and L31d are extracted from the projected cluster SC31. Contour lines L32a, L32b, L32c, and L32d are extracted from the projected cluster SC32.

A reinforcing steel bar has uneven protrusions such as lugs and ribs (see FIG. 3). Since the lugs are small in size relative to the main body of the reinforcing steel bar, the number of points corresponding to the lugs in the cluster is small, and shape errors are likely to occur. As shown in FIG. 11, it can be possible that neither the contour line L31a of the projected cluster SC31 and the contour line L32a of the projected cluster SC32 nor the contour line L31b of the projected cluster SC31 and the contour line L32b of the projected cluster SC32 match although they should match. The number of contour lines that match between the cluster C31 and the cluster C32 shown in FIG. 11 is less than two which is the threshold, and it is determined that they are not the same reinforcing steel bar. In this manner, if it is determined whether to associate clusters acquired from reinforcing steel bars as the same reinforcing steel bar without leveling, it is highly likely that the same reinforcing steel bar can be classified as a plurality of clusters or that different reinforcing steel bars can be classified as the same cluster.

In the processing device 110 according to the present example embodiment, the smoothing means 13 smooths the contours of the classified clusters. Then, the cluster association means 14 determines whether a first cluster and a second cluster contained in the smoothed clusters correspond to the same reinforcing steel bar based on the positional relation between the smoothed clusters. With these processes, it is possible to reduce the possibility that the same reinforcing steel bar is classified into a plurality of clusters or that different reinforcing steel bars are classified as the same cluster. Accordingly, it is possible to process point cloud data acquired from a plurality of reinforcing steel bars to accurately perform a bar arrangement inspection.

### First Modified Example

Next, an example of the subroutine in step S3 of FIG. 4, which is different from the subroutine of FIG. 6, is described. Note that, FIG. 2 is appropriately referred to in the following description.

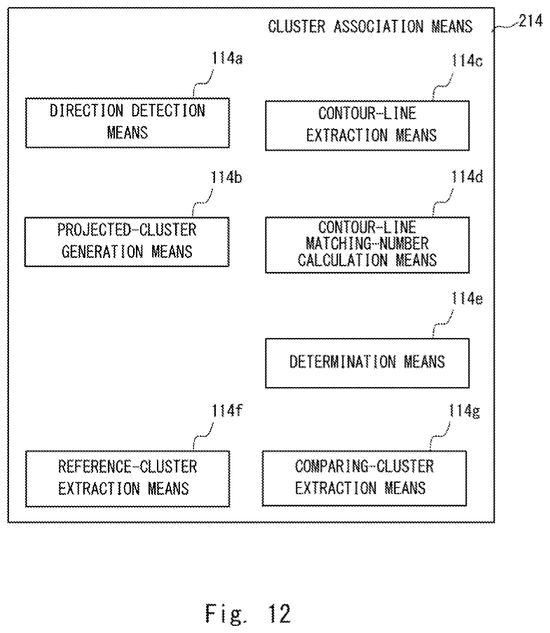

In the subroutine according to a first modified example, the only difference from the subroutine in FIG. 6 is that a pre-process described below is performed before the processes in the subroutine in FIG. 6. FIG. 12 is a block diagram showing a configuration of a cluster association means 214 according to the first modified example. As shown in FIG. 12, the cluster association means 214 according to the first modified example further includes a reference-cluster extraction means 114f and a comparing-cluster extraction means 114g in addition to the cluster association means 114 shown in FIG. 2.

The reference-cluster extraction means 114f extracts clusters whose longest directions each have a length equal to or longer than a predetermined length as reference clusters from among the smoothed clusters. Note that, an arbitrary cluster among the reference clusters is used to as a first cluster. The comparing-cluster extraction means 114g extracts clusters whose the longest directions coincide with the longest direction of the first cluster as comparing clusters from among the smoothed clusters. Note that, an arbitrary cluster among the comparing clusters is used to as a second cluster.

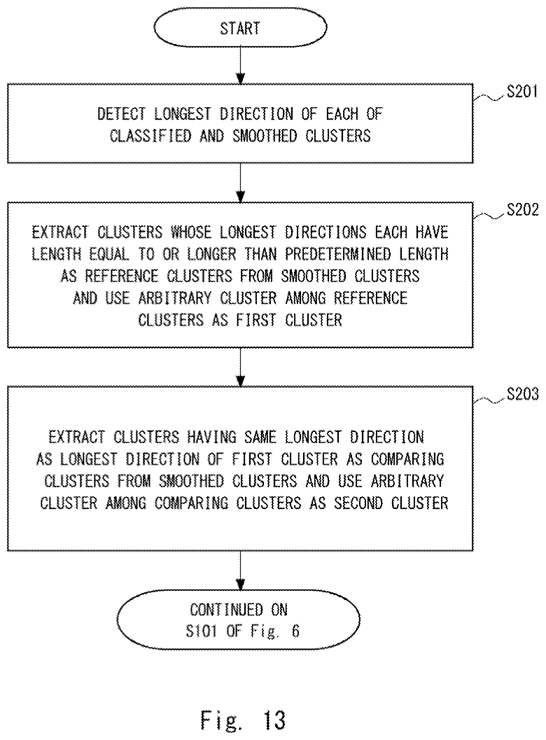

FIG. 13 is a flowchart for explaining the subroutine in step S3 of FIG. 4 according to the first modified example. As shown in FIG. 13, first, the direction detection means 114a detects the longest direction of each of the classified and smoothed clusters (step S201). Note that, the method for detecting the longest direction is performed by, for example, the above described principle component analysis. Then, the reference-cluster extraction means 114f extracts clusters whose longest directions each have a length equal to or longer than the predetermined length as reference clusters from the smoothed clusters and uses an arbitrary cluster among the reference clusters as a first cluster (step S202). Then, the comparing-cluster extraction means 114g extracts clusters having the same longest direction as the longest direction of the first cluster as comparing clusters from the smoothed clusters and uses an arbitrary cluster among the comparing clusters as a second cluster (step S203). Then, the processes in the subroutine shown in FIG. 6 are performed following step S203.

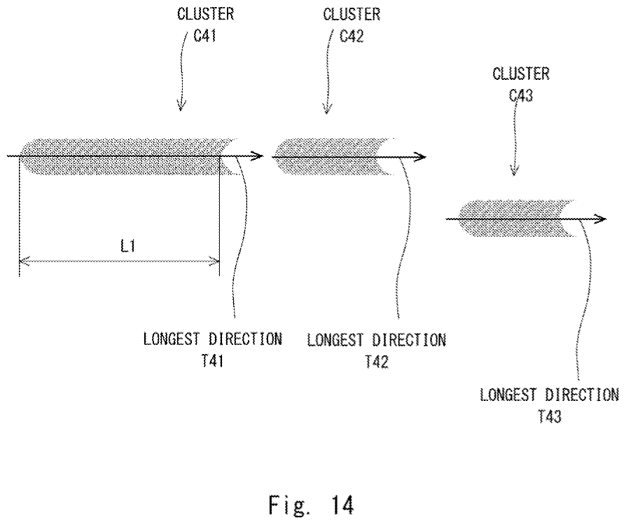

FIG. 14 is a schematic diagram for concretely explaining the processes from steps S201 to S203 shown in FIG. 13. As shown in FIG. 14, clusters acquired from a plurality of reinforcing steel bars are referred to as a cluster C41, a cluster C42, and a cluster C43. Here, when it is assumed that a length L1 of the longest direction of the cluster C41 is equal to or longer than a predetermined length Lset, the cluster C41 is a reference cluster. When it is assumed that the cluster C41 that is the reference cluster is a first cluster, a longest direction T42 of the cluster C42 is the same as a longest direction T41 of the cluster 41. Thus, the cluster C42 is used as a second cluster to determine whether to associate the cluster C41 and the cluster C42. In contrast, when it is assumed that the cluster C41 that is the reference cluster is used as a first cluster, a longest direction T43 of the cluster C43 is different from the longest direction T41 of the cluster C41. This, the consideration as to whether to associate the cluster C41 and the cluster C42 is not performed.

The arranged reinforcing steel bars each have a bar-like long thin shape. For this reason, if there is coupling relation between the clusters acquired from the reinforcing steel bars, that relation is in the longest direction. Thus, it is necessary to consider whether to associate with the first cluster only for clusters whose longest directions coincide with the longest direction of the first cluster. This can greatly reduce the calculation load. Note that, the reason that the clusters whose lengths in the longest direction equal to or longer than the predetermined length are used as reference clusters is that if the length in the longest direction of a cluster is shorter than the predetermined length, the longest direction of the cluster can be deviated from the longitudinal direction of the corresponding reinforcing steel bar due to errors.

### Second Modified Example

An example of the procedure of processing point cloud data acquired from a plurality of reinforcing steel bars in the processing device 110, which is different from FIG. 4, is described. Note that, FIG. 2 is appropriately referred to in the following description.

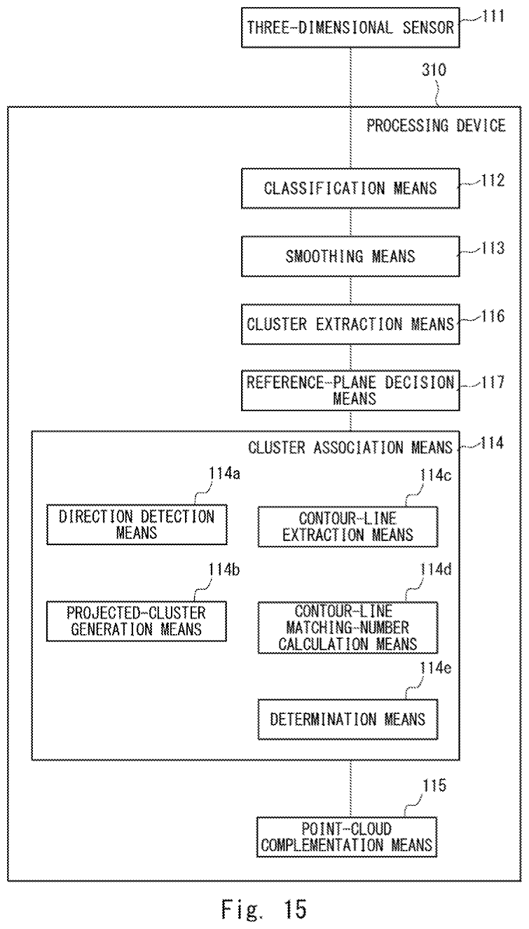

FIG. 15 is a block diagram showing a configuration of a processing device 310 according to a second modified example. As shown in FIG. 15, the processing device 310 according to the second modified example further includes a cluster extraction means 116 and a reference-plane decision means 117 in addition to the processing device 110 shown in FIG. 2. The cluster extraction means 116 extracts, as a plane decision cluster, clusters having the same longest direction from clusters corresponding to reinforcing steel bars located at a position where there is no obstruction in front of a three-dimensional sensor that irradiates a plurality of reinforcing steel bars with light. The reference-plane decision means 117 decides a first reference plane containing the plane decision cluster, a second reference plane perpendicular to the first reference plane and horizontal to the longest direction of the plane decision cluster, and a third reference plane perpendicular to the first reference plane and the second reference plane.

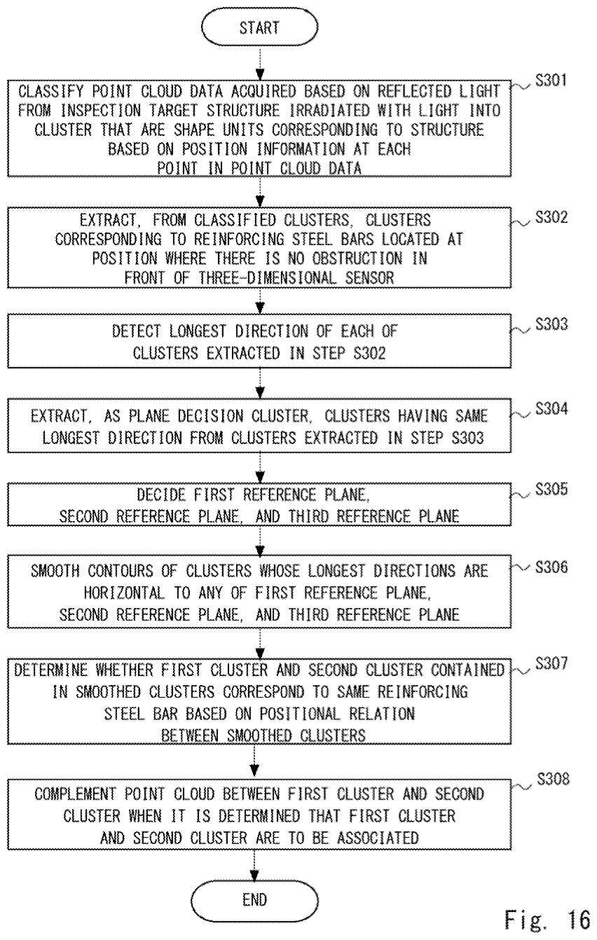

FIG. 16 is a flowchart for explaining a procedure of processing point cloud data acquired from a plurality of reinforcing steel bars in the processing device 110, and is an example different from FIG. 4. As shown in FIG. 16, first, the classification means 112 classifies point cloud data acquired based on reflected light from a plurality of reinforcing steel bars irradiated with light by the three-dimensional sensor 111 into clusters, which are shape units corresponding to the plurality of reinforcing steel bars, based on position information at each point in the point cloud data (step S301).

Following step S301, the cluster extraction means 116 extracts, from the classified clusters, clusters corresponding to reinforcing steel bars located at a position where there is no obstruction in front of the three-dimensional sensor 111 (step S302). Then, the direction detection means 114a detects the longest direction of each of the clusters extracted in step S302 (step S303). Then, the cluster extraction means 116 extracts, as a plane decision cluster, clusters having the same longest direction from the clusters extracted in step S303 (step S304).

Following step S304, the Reference-plane decision means 117 decides a first reference plane, a second reference plane, and a third reference plane (step S305). Here, the first reference plane is the plane containing the plane decision cluster, the second reference plane is the plane perpendicular to the first reference plane and horizontal to the longest direction of the plane decision cluster, and the third reference plane is the plane perpendicular to the first reference plane and the second reference plane.

Following step S305, the smoothing means 113 smooths the contours of the clusters whose longest directions are horizontal to any of the first reference plane, the second reference plane, and the third reference plane (step S306). Then, the cluster association means 114 determines whether a first cluster and a second cluster contained in the clusters whose contours have been smoothed correspond to the same reinforcing steel bar based on positional relation between the smoothed clusters (step S307). Note that, to the process in step S307, the processes in the subroutine shown in FIG. 6 are applied. Then, the point-cloud complementation means 115 complements a point cloud between the first cluster and the second cluster when the cluster association means 114 determines that the first cluster and the second cluster are to be associated (step S308).

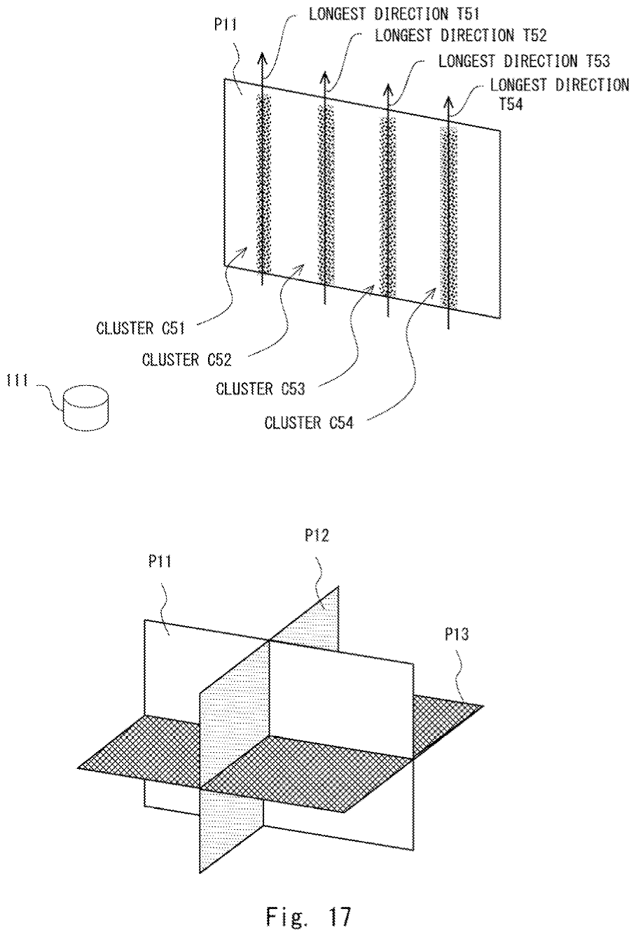

FIG. 17 is a schematic diagram for concretely explaining a process of point cloud data acquired from a plurality of reinforcing steel bars according to the second modified example. As shown in the upper part of FIG. 17, a cluster C51, a cluster C52, a cluster C53, and a cluster C54 are clusters corresponding to reinforcing steel bars located at a position where there is no obstruction from the three-dimensional sensor 111. The longest direction of the cluster C51 is referred to as a longest direction T51, the longest direction of the cluster C52 is referred to as a longest direction T52, the longest direction of the cluster C53 is referred to as a longest direction T53, and the longest direction of the cluster C54 is referred to as a longest direction T54. Here, when it is assumed that the longest direction T51, the longest direction T52, the longest direction T53, and the longest direction T54 have the same direction, the cluster C51, the cluster C52, the cluster C53, and the cluster C54 are the plane decision cluster. Thus, the plane containing the cluster C51, the cluster C52, the cluster C53, and the cluster C54, which are the plane decision cluster is a first reference plane P11.

As shown in the lower part of FIG. 17, the plane perpendicular to the first reference plane P11 and horizontal to the longest direction of the plane decision cluster is a second reference plane P12. In addition, the plane perpendicular to the first reference plane P11 and the second reference plane P12 is a third reference plane P13.

In bar arrangement, there are a number of auxiliary reinforcing steel bars (reinforcement bars) for width retention in addition to main reinforcing steel bars that contribute to the design. The reinforcement bars do not contribute to the design and do not need to be detected in a bar arrangement inspection. The longest directions of the main reinforcing steel bars are horizontal to any of the first reference plane, the second reference plane, and the third reference plane, but the longest directions of the reinforcement bars are not horizontal to any of the first reference plane, the second reference plane, and the third reference plane in many cases. As described above, by limiting clusters to be smoothed to clusters whose longest directions are horizontal to any of the first reference plane, the second reference plane, and the third reference plane, it is possible to exclude reinforcement bars from estimation of coupling relation between clusters. Accordingly, it is possible to reduce the calculation load and to improve the estimation accuracy of coupling relation of clusters.

### Third Modified Example

An example of a procedure of processing point cloud data acquired from a plurality of reinforcing steel bars in the processing device 110, which is different from FIGS. 4 and 16, is described. Note that, FIG. 2 is appropriately referred to in the following description.

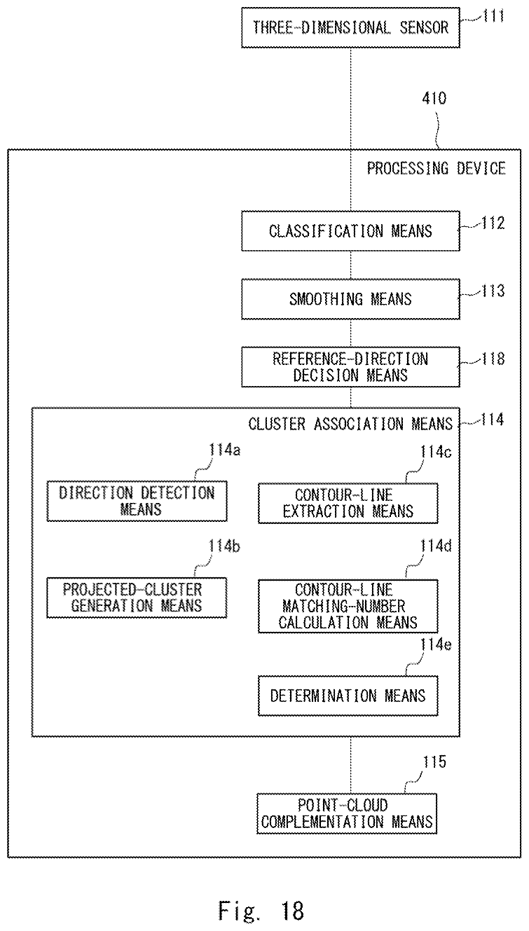

FIG. 18 is a block diagram showing a configuration of a processing device 410 according to a third modified example. As shown in FIG. 18, the processing device 410 according to the third modified example further includes a reference-direction decision means 118 in addition to the processing device 110 shown in FIG. 2. The reference-direction decision means 118 decides a first reference direction, a second reference direction, and a third reference direction. Here, the first reference direction is the direction having the highest frequency of the longest direction of each of the classified clusters. The second reference direction is the direction having the next highest frequency after the first reference direction. In the case of arranged reinforcing steel bars, the first reference direction and the second reference direction are orthogonal because most of the reinforcing steel bars are bound vertically and horizontally. The third reference direction is the direction of the outer product of the first reference direction and the second reference direction.

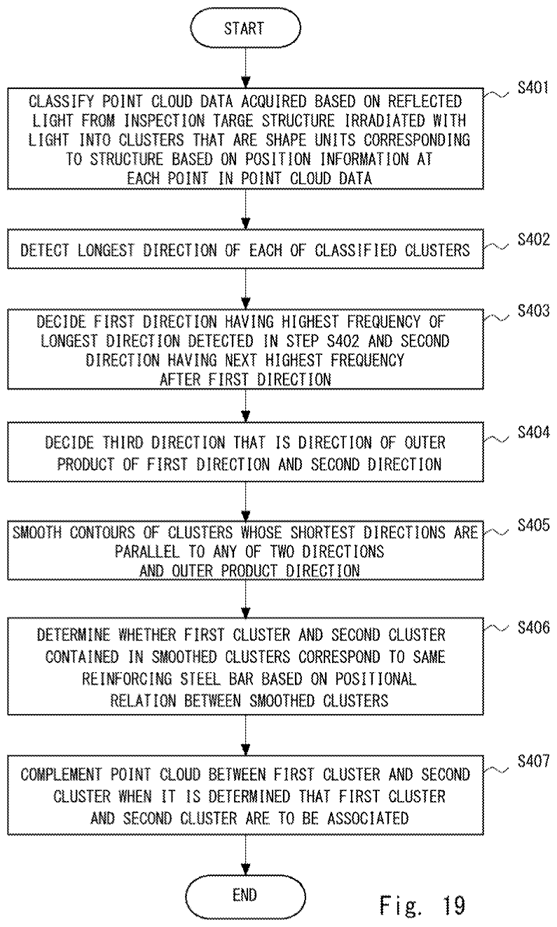

FIG. 19 is a flowchart for explaining a procedure of processing point cloud data acquired from a plurality of reinforcing steel bars in the processing device 110, and is different from FIGS. 4 and 16. As shown in FIG. 19, first, the classification means 112 classifies point cloud data acquired based on reflected light from a plurality of reinforcing steel bars irradiated with light by the three-dimensional sensor 111 into clusters, which are shape units corresponding to the plurality of reinforcing steel bars, based on position information at each point in the point cloud data (step S401).

Following step S401, the direction detection means 114a detects the longest direction of each of the classified clusters (step S402). Then, the reference-direction decision means 118 decides a first reference direction having the highest frequency of the longest direction detected in step S402 and a second reference direction having the next highest frequency after the first reference direction (step S403). Then, the reference-direction decision means 118 decides a third reference direction that is the direction of the outer product of the first reference direction and the second reference direction (step S404).

Following step S404, the smoothing means 113 smooths the contours of clusters whose shortest directions are parallel to any of the first reference direction, the second reference direction, and the third reference direction (step S405). Then, the cluster association means 114 determines whether a first cluster and a second cluster contained in the clusters whose contours have been smoothed correspond to the same reinforcing steel bar based on positional relation between the smoothed clusters (step S406). Note that, to the process in step S406, the processes in the subroutine shown in FIG. 6 are applied. Then, the point-cloud complementation means 115 complements a point cloud between the first cluster and the second cluster when the cluster association means 114 determines that the first cluster and the second cluster are to be associated (step S407).

In bar arrangement, there are a number of auxiliary reinforcing steel bars (reinforcement bars) for width retention in addition to main reinforcing steel bars that contribute to the design. The reinforcement bars do not contribute to the design and do not need to be detected in a bar arrangement inspection. The longest directions of the reinforcing steel bars are horizontal to any of the two directions and the outer product direction, but the longest directions of the reinforcement bars are not parallel to any of the two directions and the outer product direction in many cases. As described above, by limiting clusters to be smoothed to clusters whose longest directions are horizontal to any of the two directions and the outer product direction, it is possible to exclude reinforcement bars from estimation of coupling relation between clusters. Accordingly, it is possible to reduce the calculation load and to improve the estimation accuracy of coupling relation of clusters.

In the above example embodiments, the present invention is described as a hardware configuration, but the present invention is not limited thereto. The present invention can be achieved by a central processing unit (CPU) executing a program.

The program for performing the above processes can be stored by various types of non-transitory computer-readable media and provided to a computer. Non-transitory computer-readable media include any type of tangible storage media. Examples of non-transitory computer-readable media include magnetic storage media (such as flexible disks, magnetic tapes, hard disk drives, etc.), optical magnetic storage media (such as magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, an Random Access Memory (RAM)). The program may be provided to a computer using any type of transitory computer-readable media. Examples of transitory computer readable media include electric signals, optical signals, and electromagnetic waves. Transitory computer-readable media can provide the program to a computer via a wired communication line (such as electric wires, and optical fibers) or a wireless communication line.

The present invention has been described above with reference to the example embodiments but is not limited by the above. Various modifications that can be understood by those skilled in the art can be made to the configurations and the details of the present invention without departing from the scope of the invention.

### REFERENCE SIGNS LIST

10, 110, 310, 410 Processing device
12, 112 Classification means
13, 113 Smoothing means
14, 114, 214 Cluster association means
21 Projected cluster
111 Three-dimensional sensor
114a Direction detection means
114b Projected-cluster generation means
114c Contour-line extraction means
114d Contour-line matching-number calculation means
114e Determination means
114f Reference-cluster extraction means
114g Comparing-cluster extraction means
115 Point-cloud complementation means
116 Cluster extraction means
117 Reference-plane decision means
118 Reference-direction decision means

What is claimed is:

1. A processing device comprising:
at least one memory storing instructions, and
at least one processor configured to execute the instructions to;
classify three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data;
smooth contours of the classified clusters; and
determine whether a first cluster and a second cluster contained in the smoothed clusters correspond to the same reinforcing steel bar based on a positional relation between the smoothed clusters.

2. The processing device according to claim 1, wherein the at least one processor detects a longest direction, in which a largest number of points are lined, of each of the smoothed clusters, extracts clusters whose longest directions each have a length equal to or longer than a predetermined length as reference clusters from among the smoothed clusters, uses an arbitrary cluster among the reference clusters as the first cluster, and uses an arbitrary cluster among clusters whose longest directions coincide with the longest direction of the first cluster among the smoothed clusters as the second cluster.

3. The processing device according to claim 1, the at least one processor configured to execute the instructions to:
extract, as a plane decision cluster, clusters having the same longest direction from clusters corresponding to reinforcing steel bars located at a position where there is no obstruction in front of a three-dimensional sensor configured to irradiate the plurality of reinforcing steel bars with light; and
decide a first reference plane containing the plane decision cluster, a second reference plane perpendicular to the first reference plane and horizontal to the longest direction of the plane decision cluster, and a third reference plane perpendicular to the first reference plane and the second reference plane, wherein
the at least one processor smooths clusters having longest directions horizontal to any of the first reference plane, the second reference plane, and the third reference plane.

4. The processing device according to claim 1, the at least one processor configured to execute the instructions to:
decide a first reference direction having the highest frequency of the longest direction of each of the classified clusters, a second reference direction having the next highest frequency after the first reference direction, and a third reference direction that is a direction of an outer product of the first reference direction and the second reference direction, wherein
the at least one processor smooths clusters having longest directions parallel to any of the first reference direction, the second reference direction, and the third reference direction.

5. A processing method comprising the steps of:
classifying three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data;
smoothing contours of the classified clusters; and
determining whether a first cluster and a second cluster contained in the classified clusters correspond to the same reinforcing steel bar based on a positional relation between the smoothed clusters.

6. A non-transitory computer-readable medium storing a program causing a computer to execute the steps of:
classifying three-dimensional point cloud data acquired based on reflected light from a plurality of reinforcing steel bars irradiated with light in a bar arrangement inspection into clusters, the clusters being shape units corresponding to the plurality of reinforcing steel bars, based on position information at each point in the three-dimensional point cloud data;
smoothing contours of classified clusters; and
determining whether a first cluster and a second cluster contained in the classified clusters correspond to the same reinforcing steel bar based on a positional relation between the smoothed clusters.
